(19) United States
(12) Patent Application Publication
(10) Pub. No.: US 2008/0230036 A1
(43) Pub. Date: Sep. 25, 2008

(54) Roller actuator for a mechanical fuel pump

(76) Inventors: William D. Bauman, Dorr, MI (US); Ralph L. Clayson, Grand Rapids, MI (US); David Draeger, Byron Center, MI (US); Timothy W. Kunz, Rochester, NY (US); Daniel F. Smith, Conesus, NY (US)

Correspondence Address: DELPHI TECHNOLOGIES, INC., M/C 480-410-202, PO BOX 5052, TROY, MI, 48007, US

(21) Appl. No.: 12/077,857

(22) Filed: Mar. 21, 2008

Related U.S. Application Data
(60) Provisional application No. 60/919,663, filed on Mar. 23, 2007.
(60) Provisional application No. 60/995,803, filed on Sep. 28, 2007.

(51) Int. Cl. F02M 37/06

(52) U.S. Cl. 123/508

(57) ABSTRACT

A fuel pump actuator comprising a body portion and a contact end fitted to the body portion for actuating a mechanical fuel pump in response to a camshaft lobe. A roller mounted to the body portion is configured to ride on the lobe. The contact end of the actuator engages a plunger of the fuel pump. The body portion of the actuator is preferably a body portion of a conventional hydraulic valve lifter and preferably includes a lash adjuster and is reciprocally disposed in a bore on the engine block. Lubrication of the reciprocating actuator is also similar to the lubrication provided to conventional valve lifters and lash adjusters. The contact end of the actuator is configured to reduce the mass of the actuator. Several styles of the contact end and ways of attaching the contact end to the body portion are provided.

### RELATIONSHIP TO OTHER APPLICATIONS AND PATENTS

This application claims the benefit of U.S. Provisional Patent Application No. 60/919,663, filed Mar. 23, 2007, and U.S. Provisional Patent Application No. 60/995,803, filed Sep. 28, 2007.

### TECHNICAL FIELD

The present invention relates to a fuel pump actuator for transferring the rotational motion of an eccentric camshaft lobe to the reciprocating motion of a high pressure mechanical fuel pump.

### BACKGROUND OF THE INVENTION

Fuel injected gasoline engines have become commonplace in the automotive industry for some time. Fuel injection of the most current technology has evolved into two categories—multi-port fuel injection (MPFI), wherein fuel is injected into the runners of an air intake manifold ahead of the cylinder air intake valves, and direct fuel injection (DFI) wherein fuel is injected directly into the engine cylinders, typically during or at the end of the compression strokes of the pistons. Diesel fuel injection is also a direct injection type.

Direct injection fuel delivery systems operate at much higher fuel pressures than do MPFI fuel delivery systems to assure proper injection of fuel into a cylinder having a compressed charge. DFI fuel rails that supply fuel to the fuel injectors may be pressurized to 100 atmospheres or more, for example, whereas MPFI fuel rails must sustain pressures of only about 4 atmospheres.

Fuel delivery for MPFI systems has been achieved in the prior art by an electric fuel pump mounted in the fuel tank. Fuel is delivered, under pressure, to the fuel rail(s) mounted on the engine from the fuel tank via a fuel line running the length of the vehicle. Because of the higher delivery pressures needed in a DFI system, current direct injection designs favor a high pressure mechanical fuel pump mounted close to the fuel rails(s) to minimize the fuel line length and the number of line connections between the pump and the fuel rail(s).

What is needed in the art is a low cost fuel pump actuator for transferring the rotational motion of a camshaft lobe to the reciprocating motion of a mechanical fuel pump that has a low mass, is durable, and can be readily retrofitted to current engine architecture with minimal new tooling.

What is further needed is a fuel pump actuator that can also absorb mechanical lash between the camshaft lobe and the fuel pump.

It is a principal object of the present invention to provide such a fuel pump actuator.

### SUMMARY OF THE INVENTION

Briefly described, a mechanical fuel pump actuator in accordance with the invention comprises a body portion and a contact end fitted to the body portion. A roller mounted to the body portion is configured to ride on a camshaft lobe. The contact end of the actuator is for contact with a plunger of a mechanical fuel pump. The body portion of the actuator preferably is identical to a body portion of a conventional hydraulic valve lifter body, to gain commonality with existing parts and minimize added cost, and is disposable in a bore on the engine block similar to bores provided in the block for conventional hydraulic valve lifters.

In one aspect of the invention, the body portion also includes a hydraulic lash adjuster that extends the contact end of the actuator to absorb mechanical lash between the cam lobe and the fuel pump plunger.

Lubrication of the reciprocating actuator is provided via an oil gallery in the engine. The contact end of the actuator is formed of thin sheet metal and is configured to reduce the mass of the actuator. Several ways of attaching the contact end to the body portion are provided. The fuel pump actuator, in accordance with the invention, can be readily retrofitted to existing engine architecture with minimal changes to the mounting platform and with minimal new tooling needed for the actuator.

### BRIEF DESCRIPTION OF THE DRAWINGS

The present invention will now be described, by way of example, with reference to the accompanying drawings, in which:

FIG. 1 is an isometric view from above of exemplary left and right fuel rail assemblies as formed for the left and right heads of a DFI V-8 engine;

FIG. 2 is a sectioned view of the fuel pump actuating system taken along line 2-2, as shown in FIG. 3;

FIG. 3 is a side view of the fuel pump actuation system, in accordance with the invention, as installed in an OHV engine;

FIG. 4 is a sectioned view of an actuator and a contact end in accordance with one embodiment of the invention;

FIGS. 5a and 5b are sectioned views of an actuator and contact ends in accordance with another embodiment of the invention;

FIGS. 6a-6e are sectioned views of various contact ends in accordance with the invention;

FIGS. 7a and 7b are sectioned views of an actuator and a contact end in accordance with yet another one embodiment of the invention;

FIG. 8 is a sectioned view of an actuator and a contact end in accordance with still another one embodiment of the invention;

FIGS. 9a-9d are sectioned views of another actuator and several additional contact ends in accordance with the invention;

FIG. 10 is an elevational view of a spring retainer and contact end modified to provide lubricant to the outer surface of the contact end;

FIGS. 11a and 11b show two approaches for providing accurate angles of an oil orifice in the contact end;

FIGS. 12a through 12d show various possible configurations of oil orifices in accordance with the present invention;

FIG. 13 is an elevational cross-sectional view of a prior art hydraulic valve lifter with internal lash adjustment; and

FIG. 14 is an elevational cross-sectional view of a fuel pump actuator in accordance with the invention that employs the hydraulic valve lifter mechanism shown in FIG. 13.

### DESCRIPTION OF THE PREFERRED EMBODIMENTS

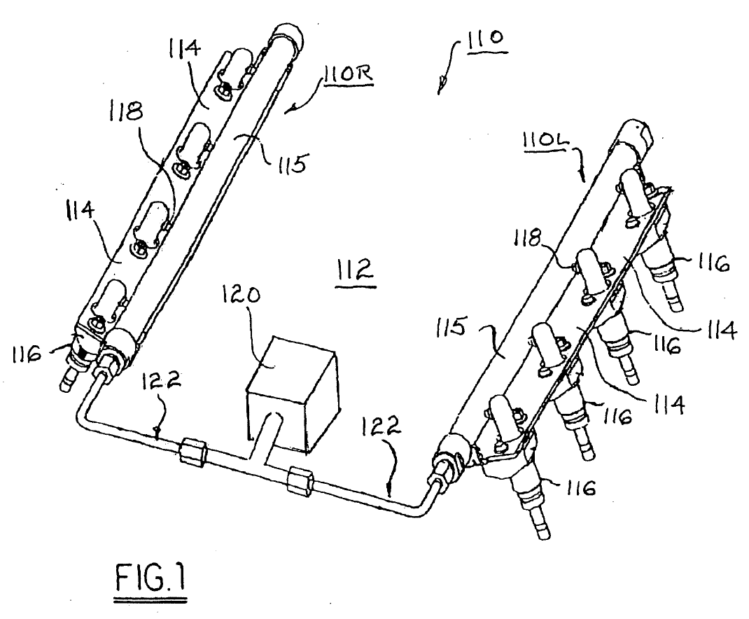

Referring to FIG. 1, two fuel rail assemblies 110 of a direct injection system are shown exemplarily arranged as for use on a DFI V-8 engine 112 (left assembly 110L, right assembly 110R). Fuel rail assembly 110 comprises metal brackets 114 by which fuel rails 115 are mounted to the cylinder heads (not shown) of engine 112. Injectors 116 receive fuel, under pressure from rails 115, through, for example, jump tubes 118 for delivery of metered fuel, by the injectors, directly into the cylinder combustion chambers (not shown). Fuel is delivered to fuel rails 115, typically at above 100 bar, by high pressure mechanical fuel pump 120 through delivery tube 122. Pump 120 is mounted to engine 112 in the valley of the engine block and close to the fuel rails. Pump 120 is actuated by a reciprocating fuel pump actuator slidably mounted in a bore in the engine block and in contact with a dedicated lobe on the engine camshaft. A fuel pump actuator in accordance with the present invention will now be described.

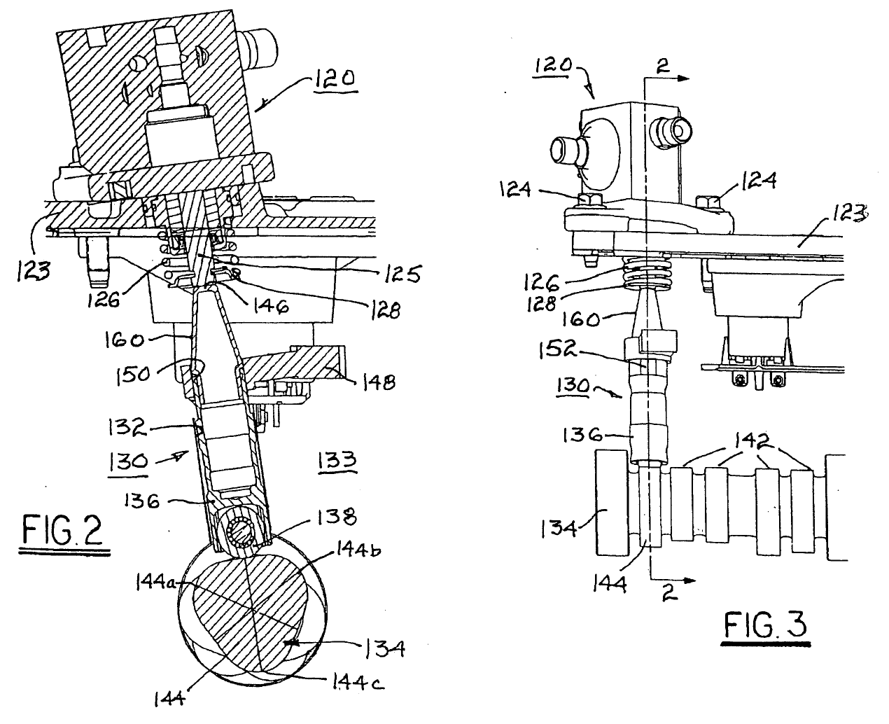

Referring to FIGS. 2 and 3, elongate fuel pump actuator 130 is shown slidably mounted in bore 132 of engine block 133 directly above camshaft 134. Actuator 130 includes body portion 136 to which roller 138 is rotatably mounted, and contact end 160. Actuator body portion 136 may be formed in any shape desired; however, to minimize the cost of tooling and to assure reliability of function, actuator body portion 136 preferably is generally identical to the body portion of a conventional hydraulic roller lifter (HRL) as is known to be used on the type of engine 112 shown in FIG. 1. Lubrication of roller 138 and the reciprocating actuator 130 within engine bore 132 is accomplished in the same way that roller valve lifter followers are lubricated. Oil is splashed up from the rotating crank shaft to lubricate the rollers and may also be positively fed to the body portions of the actuators through oil galleries (not shown) in the engine block in communication with actuator body portions 136.

Contact end 160 of actuator 130 may be deep drawn from sheet stock of a low carbon steel, such as 1010 or 1012 steel, then hardened by heat treat. Camshaft 134 includes lobes 142 for actuating associated intake and exhaust combustion valves (not shown), and fuel pump lobe 144. Lobe 144 includes equally spaced tri-lobes 144a, b and c. Pump 120 is mounted above bore 132 and in the valley of the engine, as for example, to lifter oil manifold assembly 123, by bolts 124. Pump plunger 125 extends from pump 120 for reciprocation by actuator 130 and contact end 160. Plunger return spring 126 is trapped between return spring seat 128 and a bottom surface of pump 120. In the assembled position shown in FIGS. 2 and 3, tip 146 of contact end 160 of the actuator is in contact with pump plunger 125. Roller 138 of body portion 136 of the actuator is in contact with fuel pump lobe 144 so that, for each revolution of camshaft 134 (or every two revolutions of the engine crank shaft), actuator 130 causes pump plunger 125 to fully reciprocate three times. It is important that the path of rotation of roller 138 stays in line with the path of rotation of lobe 144. To achieve this, anti-rotation guide 148 is provided. Guide 148 is fixed to engine block 133 after assembly of actuator 130 into the engine such as, for example, by a bolt (not shown). Body portion 136 passes through close-fitting bore 150 of guide 148. Bore 150 includes a flatted segment (not shown) that matingly engages flatted segment 152 of body portion 136. In operation, bore 150 permits free reciprocation of actuator 130 in block bore 132 while the mating flatted segments prevent actuator 130 from rotating on its longitudinal axis. Thus, the path of rotation of roller 138 is kept aligned with fuel pump lobe 144.

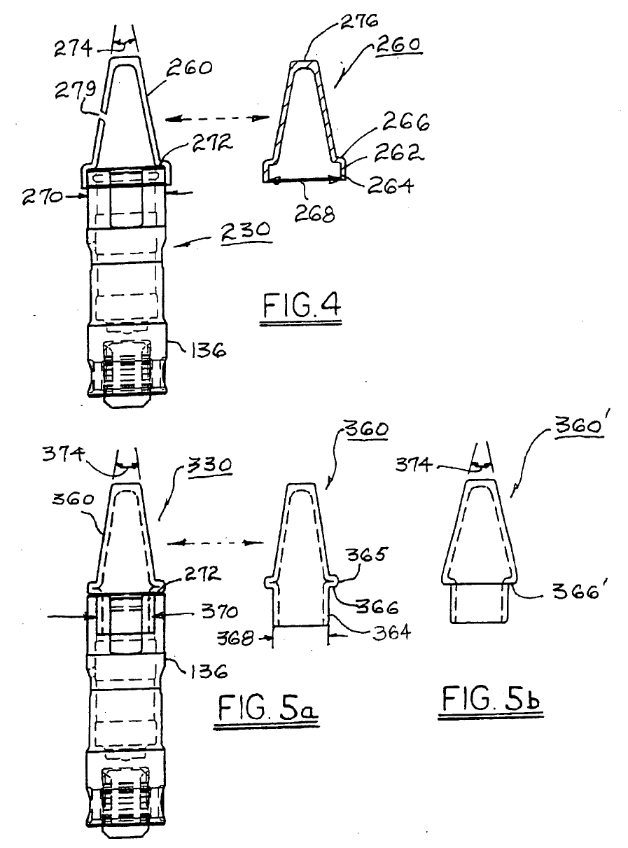

Referring to FIG. 4, an alternate embodiment of actuator 130 is shown. Actuator 230 includes body portion 136 (of a convention roller lifter) and contact end 260. Flange 262 is formed at one end of contact end 260. Flange 262 includes collar 264 and shoulder 266. The inside diameter 268 of collar 264 is sized to fit snugly around the outside diameter 270 of body portion 136 to keep contact end 260 in place while actuator 230 is in shipment to the engine assembly plant. Shoulder 266 of flange 262 seats against the top edge 272 of body portion 136 so that the load imparted on contact end 260 by the actuation of plunger 125 is transferred directly through body portion 136 and to the fuel pump lobe. At 1000 engine RPMs, actuator 130/230 is reciprocating 25 times per second. Therefore, it is important that the mass of the actuator be kept to a minimum. To reduce mass, contact end 260 is formed from thin sheet steel and includes a reduced diameter portion such as, for example, a taper 274 and flat surface 276 for making contact with the pump plunger. Flat surface 276 is of a reduced diameter to improve rigidity of the contact surface. Contact end 260 preferably is case hardened, after forming, to improve durability.

Optionally, an oil metering orifice 279 may be provided in contact end 260 to permit oil to freely exit the actuator for lubrication purposes. Preferred arrangements for such an oil orifice, including means for supplying oil to the interior of body portion 136, are described more fully below.

Referring to FIG. 5a, another embodiment 330 of the actuator is shown. Actuator 330 includes body portion 136 (of a convention roller lifter) and contact end 360. Rather than fitting around the outside diameter of the body portion, as in actuator 230, contact end 360 fits inside body portion 136. The outside diameter 368 of collar 364 of the contact end is sized to fit snugly into the inside diameter 370 of body portion 136 to keep the components together while in shipment. Shoulder 366 formed at the underside of bead 365 seats against the top edge 272 of body portion 136 so that the load imparted on contact end 360 by the actuation of plunger 125 is transferred directly through body portion 136 to the cam lobe. Taper 374 is included in contact end 360 to reduce mass and to increase contact surface rigidity; contact end 360 is case hardened, after forming, to improve durability.

FIG. 5b shows a slight variation of contact end 360 shown in FIG. 5a. Contact end 360′, shown in FIG. 5b, includes shoulder 366′ formed at the bottom end of taper 374. Shoulder 366′ seats against the top edge 272 of body portion 136 so that the load imparted on contact end 360′ by the actuation of plunger 125 is transferred directly through body portion 136 to the cam lobe.

FIGS. 6a-6e show various alternate versions of the contact end. 360′a is shown without taper 374; 360′b with a reverse taper; and 360′c with a closed contact end to maximize reduction in mass. 360′d and 360′e show contact end 360 formed in two pieces and in three pieces, respectively (the versions shown in FIGS. 6a-6e may also be incorporated in the “outside-fitting” contact end version depicted in FIG. 4). In 360′d and 360′e, tip 346 may be formed of a material highly resistant to wear, then fixed to the lower section of the contact end, such as by welding or bonding.

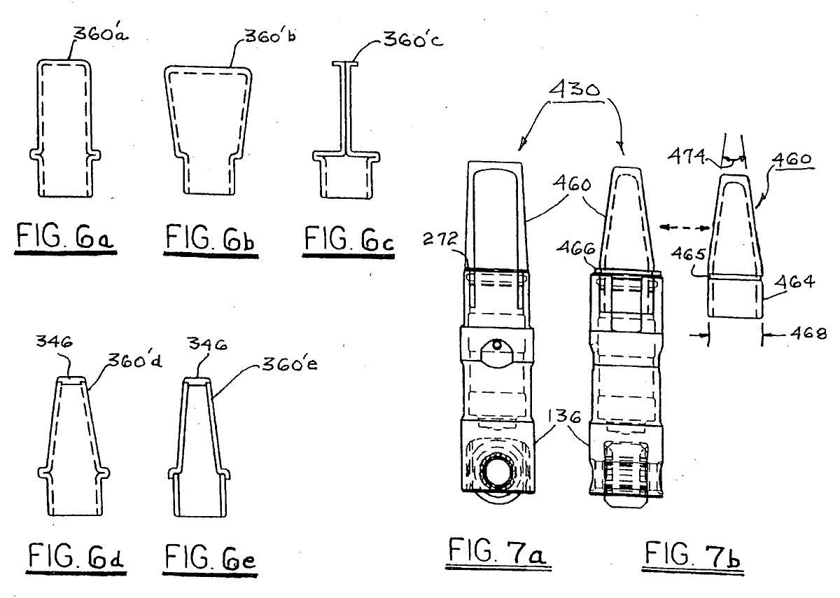

Referring to FIGS. 7a-7b, yet another embodiment 430 of the actuator is shown. Actuator 430 includes body portion 136 (of a convention roller lifter) and contact end 460. Like embodiment 330, contact end 460 fits inside body portion 136. The outside diameter 468 of collar 464 of the contact end is sized to fit snugly into the inside diameter of body portion 136 to keep the components together while in shipment. Clip 466 fits into groove 465 formed annularly around collar 464 and seats against the top edge 272 of body portion 136 so that the load imparted on contact end 460 by the actuation of plunger 125 is transferred directly through body portion 136 to the cam lobe. A reduced diameter portion such as taper 474 is included in contact end 460 to reduce mass and to increase contact surface rigidity; contact end 460 is case hardened, after forming, to improve durability.

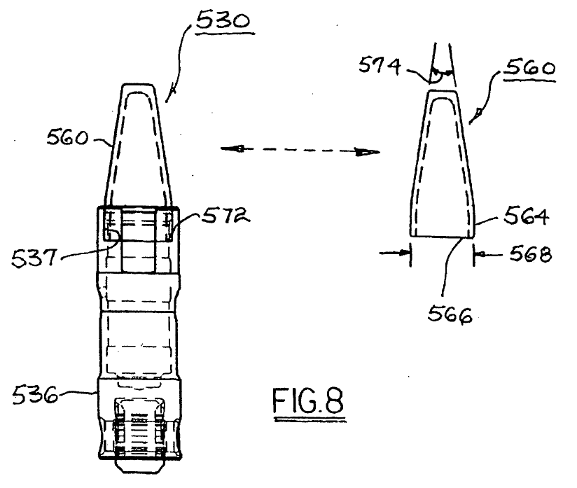

Referring to FIG. 8, yet another embodiment 530 of the actuator is shown. In this embodiment, additional machining of the conventional lifter body portion is needed. Actuator 530 includes modified body portion 536 and contact end 560. Body portion 536 includes counterbore 537 having ledge 572. Collar 564 of contact end 560 fits inside counterbore 537 of body portion 536. The outside diameter 568 of straight-sided collar 564 of the contact end is sized to fit snugly into the inside diameter of counterbore 537 to keep the components together while in shipment. End surface 566 of collar 564 seats against ledge 572 of body portion 536 so that the load imparted on contact end 560 by the actuation of plunger 125 is transferred directly through body portion 536 and to the cam lobe. Reduced diameter taper 574 is included in contact end 560 to reduce mass and to increase contact surface rigidity; contact end 560 is case hardened, after forming, to improve durability. A ferritic carbonitride hardening process is preferred to minimize dimensional distortion of collar 564 so that it may be close-fittingly inserted into counterbore 537. Alternately, a regular carborizing process can be use to harden contact end 560 so that small and controlled distortion of collar 564 occurs. The slight amount of controlled distortion would cause a limited interference-fit to occur between the collar and counterbore to permit assembly but to resist unwanted self-disassembly during shipment because of the interference. This process for providing a controlled distortion may be used in conjunction with any embodiment described.

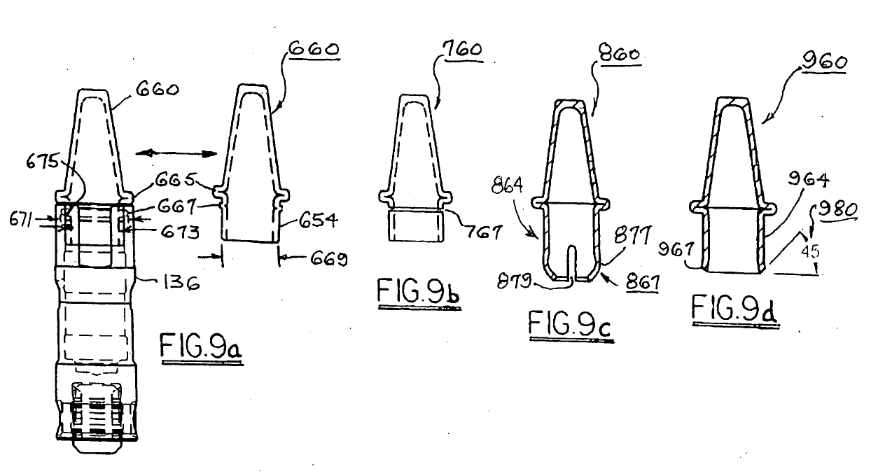

In the embodiments described above, a small degree of interference fit between the contact end and the body portion is desirable in order to prevent the actuator from becoming disassembled during shipment. Various alternate ways of keeping the actuator assembled during shipment are shown in FIGS. 9a-9d. In contact end 660, a secondary and smaller bead 667 is formed below bead 665. As in contact end 360, bead 665 seats against the top edge of body portion 136 so that the load imparted on contact end 660 by the actuation of plunger 125 is transferred directly through body portion 136 to the cam lobe. Secondary bead 667 provides a means for keeping the actuator assembled during shipment. Diameter 669 of collar 654 is smaller than the existing inside diameter 673 of body portion 136 while diameter 671 across secondary bead 667 is slightly greater than diameter 673. The axial position of secondary bead 667 relative to the bottom of bead 665 is selected so that secondary bead 667 lines up with existing groove 675 in body portion 136. Thus, when bead 665 is seated against the top edge of body portion 136, secondary bead 667 will line up with and become seated in groove 675 thereby resisting self-disassembly of the actuator during shipment.

Referring to FIG. 9b, contact end 760 is similar to contact end 660 except, instead of secondary bead 667, contact end 760 has an annular groove 767 for receiving a wire clip (not shown). The axial position of the groove relative to the bottom of bead 765 is selected so that the groove lines up with an existing groove in body portion 136. Prior to assembling contact end 760 to the body portion, the c-shaped wire clip (not shown) is inserted into groove 767. The free diameter of the wire clip is slightly larger than the inside diameter of the body portion. Thus, when bead 765 is seated against the top edge of body portion 136, the wire clip will expand outward and will become seated in groove 675 and remain at least partially seated in groove 767, thereby resisting self-disassembly of the actuator during shipment.

Contact end 860 in FIG. 9c shows yet another embodiment for keeping the components together during shipment. Collar 864 includes bulbous open end 867. A portion 877 of the bulbous end is of a diameter slightly larger than the inside diameter of the body portion. When contact end 860 is inserted into the body end, a slight interference fit exists, thereby resisting self-disassembly of the components. Relief slit 879 permits a slight flexing of the bulbous end when it is inserted into the body portion.

Contact end 960 in FIG. 9d shows still another embodiment for keeping the components together during shipment. Collar 964 includes flared open end 967. The end portion of the flared end is of a diameter slightly larger than the inside diameter of the body portion. When contact end 960 is inserted into the body end, a slight interference fit exists, thereby resisting self-disassembly of the components. A 45 degree lead chamfer 980 may be added to the flared end to aid in the insertion of the flared end.

Referring again to FIGS. 2 and 4, oil metering orifice 279 may be configured to preferentially provide a spray of lubricant to the interface between end surface 276 and pump plunger 125.

Referring now to FIGS. 10, 11a-11b, and 12a-12d, a modified return spring seat 942 defines a hat-shaped element having a deep well 943, preferably slightly tapered, into which a generic contact end 130 extends. Seat 942 includes a flange portion 945 for engaging the pump return spring 926 (requires a longer spring than spring 126 in FIGS. 2 and 3), and a central opening 927 for passage of pump plunger 125. The axis 981 of a modified oil orifice 979 is positioned such that Angle A equals Angle B, causing oil spraying from orifice 979 to be reflected from the inner surface of well 943 along path 983 which provides lubrication to surface 276. The orifice may be of uniform diameter through the wall section or may be variable in diameter such that the minimum diameter provides a flow-metering restriction.

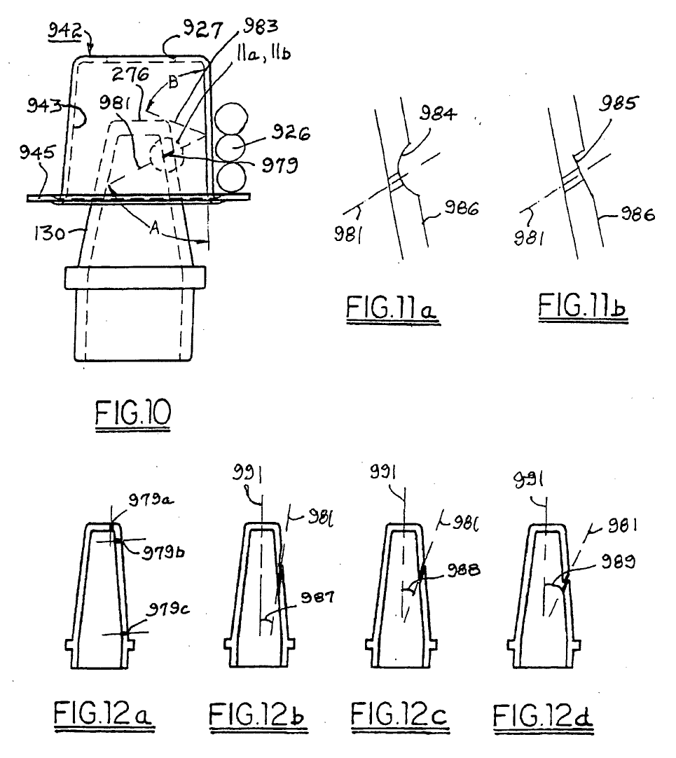

Drilling of oil orifice 979 at an accurate angle may be assisted by first providing either a radial feature 984 (FIG. 11a) or an angled flat 985 (FIG. 11b) in the outer surface 986 of contact end 130. In this manner, any desired exit angle for oil orifice 979 and axis 981 may be provided accurately, for example, axial angles 987 (FIG. 12b), 988 (FIG. 12c), or 989 (FIG. 12d) formed with actuator axis 991. Alternatively, lubrication may be provided via a plurality of small orifices 979a, 979b, 979c (FIG. 12a) having a total cross-sectional area approximating that of orifice 979.

The novel fuel pump actuator as described to this point employs a generic body 136 that may be formed by any convenient method but preferably is a body for a conventional hydraulic valve lifter. It further will be obvious that some benefit is to be gained, at a cost of additional complexity and expense, by employing not only the body but also a hydraulic valve lifter's internal lash adjustment mechanism such that the fuel pump actuator also is provided with lash adjustment capability in the linkage between the cam lobe and the pump plunger. Of course, the pump return spring also functions to eliminate lash in the system, but if the authority of the spring is exceeded, additional lash-elimination measures are desirable.

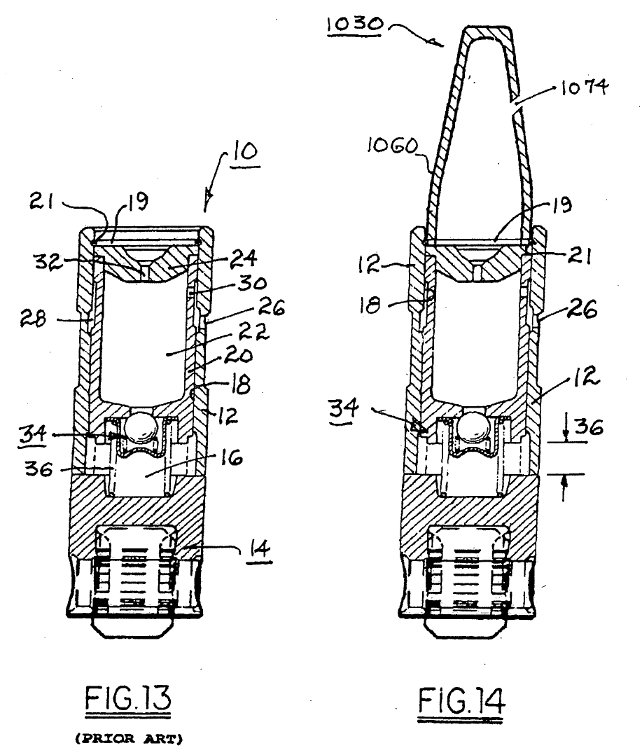

Referring to FIG. 13, a conventional hydraulic valve lifter 10 includes a body 12 to which is attached a roller mechanism 14 for engaging a cam lobe. A high-pressure oil chamber 16 is formed within a bore 18 in the lifter body between the lifter body and a hollow plunger 20 slidingly disposed in bore 18. A low-pressure oil reservoir 22 is formed between plunger 20 and a pushrod seat 24. Oil is supplied to reservoir 22 from an engine oil gallery (not shown) into lifter 10 via first port 26 in body 12 (mating with an engine oil gallery, not shown), annular chamber 28, and second port 30. Oil flows out of reservoir 22 via axial passage 32 in pushrod seat 24 to lubricate a pushrod (not shown) and upper valve train (not shown). Pushrod seat 24 is retained within bore 18 and limited in axial travel by a ring 19 disposed in an annular groove 21 formed in bore 18. A check valve 34 is disposed between the reservoir 22 and the high-pressure chamber 16. A lash adjustment spring 36 within high-pressure chamber 16 urges plunger 20 and pushrod seat 24 toward the pushrod, thus eliminating lash in an associated valvetrain. Such motion draws oil into high-pressure chamber 16 through check valve 34 from reservoir 22.

Referring now to FIG. 14, a fuel pump actuator 1030 in accordance with the present invention employs the elements just described of prior art hydraulic valve lifter 10 except that pushrod seat 24 is modified in the form of a contact end 1060 extending from body 12 and restrained within bore 18 by ring 19 and groove 21. Of course, a contact end having an open end as described variously above may be mounted on pushrod seat 24 or a simple substitute plate (not shown). Thus contact end 1060 has an axial range of lash adjustment authority within body 12 equivalent to the axial depth 36 of high-pressure chamber 16. Preferably, contact end 1060 is provided with an oil spray orifice 1074 as described above. Optionally, axial passage 32, whether in a modified pushrod seat or a substitute plate, may be formed having a specified diameter to function as an oil-metering orifice into contact end 1060, thus defining a metering plate. Care must be taken to maintain pressure within the lifter body sufficient to provide compressive competence and lash control within pump actuator 1030.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An actuator for actuating a fuel pump in response to rotation of a camshaft lobe on a camshaft in an internal combustion engine, comprising:
a) an actuator body for being slidably disposed in a bore in said engine for engaging said camshaft lobe; and
b) a contact end disposed on said actuator body for engaging said fuel pump.

2. An actuator in accordance with claim 1 wherein said actuator body further comprises a roller assembly for following said camshaft lobe.

3. An actuator in accordance with claim 1 wherein said actuator body is substantially identical to a hydraulic valve lifter body.

4. An actuator in accordance with claim 3 wherein said actuator further includes a lash adjustment mechanism disposed within said hydraulic valve lifter body and a port in said body for receiving oil from an engine oil gallery.

5. An actuator in accordance with claim 4 further comprising a metering plate having an orifice for metering oil flow from said hydraulic valve lifter body into said contact end.

6. An actuator in accordance with claim 1 wherein said contact end includes a collar having a first outside diameter and wherein a portion of said contact end has a second outside diameter of a size different than said first outside diameter.

7. An actuator in accordance with claim 6 wherein said contact end includes a taper portion.

8. An actuator in accordance with claim 1 wherein said contact end is formed from sheet stock steel.

9. An actuator in accordance with claim 1 wherein a portion of said contact end fits within a bore of said actuator body.

10. An actuator in accordance with claim 1 wherein a portion of said contact end fits around an outer diameter of said actuator body.

11. An actuator in accordance with claim 1 wherein said contact end includes a shoulder configured for making contact with an end of said body portion.

12. An actuator in accordance with claim 11 wherein said contact end includes a feature configured for causing an interference fit between said contact end and said actuator body.

13. An actuator in accordance with claim 1 wherein said contact end is provided with an oil spray exit orifice.

14. An actuator in accordance with claim 13 wherein a surface region of said contact end adjacent said oil spray orifice is formed in a shape selected from the group consisting of spherical and flat.

15. An actuator in accordance with claim 13 wherein an axis of said oil spray orifice forms an angle with a longitudinal axis of said actuator.

16. An actuator in accordance with claim 13 comprising a plurality of oil spray orifices.

17. An actuator in accordance with claim 1 wherein said camshaft further includes a second camshaft lobe for actuating at least one combustion valve of said internal combustion engine.

18. An internal combustion engine comprising:
a) a plurality of fuel injectors;
b) a fuel rail for supplying fuel to said fuel injectors;
c) a mechanical fuel pump for supplying fuel to said fuel rail; and
d) an actuator for actuating said fuel pump in response to rotation of a camshaft lobe in said engine, said actuator having a body slidably disposed in a bore in said engine for engaging said camshaft lobe, and having a contact end disposed on said actuator body for engaging said fuel pump.

19. An internal combustion engine in accordance with claim 18 wherein said engine is selected from the group consisting of multi-port fuel injected and direct fuel injected.

20. An internal combustion engine in accordance with claim 18 wherein said contact end includes at least one oil spray orifice.
